(19) United States
(12) Patent Application Publication
(10) Pub. No.: US 2026/0119072 A1
(43) Pub. Date: Apr. 30, 2026

(54) STREAMING OF A FILESYSTEM IMAGE FROM AN IMAGE STORE TO A HOST SYSTEM

(71) Applicant: Microsoft Technology Licensing, LLC, Redmond, WA (US)

(72) Inventors: Tianrui WU, Seattle, WA (US); Shaheed Gulamabbas CHAGANI, Redmond, WA (US); Abhijeet GAUTAM, Issaquah, WA (US); Taylor Alan HOPE, Redmond, WA (US); Andrew Matt COZBY, Seattle, WA (US); Amit Abhiji BARVE, Redmond, WA (US); Aparajita DUTTA, Redmond, WA (US); Yi Jun LIU, Renton, WA (US)

(21) Appl. No.: 18/933,278

(22) Filed: Oct. 31, 2024

(51) Int. Cl. G06F 3/06; G06F 9/455

(52) U.S. Cl. CPC G06F 3/0655; G06F 3/0604; G06F 3/067; G06F 9/45558; G06F 2009/45579

(57) ABSTRACT

A method executed by a host computer system with a processor system involves initiating a guest context that depends on a filesystem image stored in a remote image repository. A reflector disk is generated for the filesystem image, representing data blocks without storing them. Upon receiving a read request at the reflector disk specifying an offset and length within the filesystem image, a set of data blocks is retrieved from the remote repository corresponding to the specified range. The reflector disk then provides the retrieved data blocks to the requester, enabling efficient access to filesystem data without storing the actual data blocks locally.

### BACKGROUND

It is common for modern computer systems to create different guest compute environments (also referred to as “guest environments” or “guest contexts”) using isolation technologies. In general, isolation refers to the ability of a computer system to provide guest contexts in which one or more processes or even an entire operating system (OS) run in relative isolation. For instance, OS-level virtualization technologies refer to isolation techniques in which guest contexts are isolated user-space instances created by a host OS kernel and in which user-space processes run on top of that kernel in isolation from other guest contexts created by the same kernel. Examples of OS-level virtualization technologies include containers (DOCKER), Zones (SOLARIS), and jails (FREEBSD). Hypervisor-based virtualization technologies refer to isolation techniques in which guest contexts are virtual hardware machines (virtual machines, or VMs) created by a host OS that includes a hypervisor and in which an entire additional OS can run in isolation from other VMs. Examples of hypervisor-based virtualization technologies include HYPER-V (MICROSOFT), XEN (LINUX), VMWARE, VIRTUALBOX (ORACLE), and BHYVE (FREEBSD). A host system is a computer system that creates and manages guest contexts, such as containers (e.g., a “container host system” or “container host”) or VMs (e.g., a “VM host system” or “VM host”). Some host systems may combine the OS-level and hypervisor-based virtualization technologies, e.g., by running a container within a lightweight VM.

Regardless of the isolation technology used, a guest context generally needs access to a filesystem volume, such as a filesystem volume comprising files for an OS, files for applications, etc. As such, various disk and/or filesystem “image” formats are employed by various isolation techniques, each with benefits and drawbacks. One commonly used filesystem image format is the tarball (TAR) format, a compressed archive of files and/or directories. A TAR is a single file that contains the contents and metadata of one or more other files and/or directories. The TAR format preserves file permissions, ownership, timestamps, symbolic links, and hard links. The TAR format can be compressed using various compression algorithms, such as gzip, bzip2, xz, and zstd. The TAR format can create a filesystem image containing the files and directories required for a guest context.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a request to start a guest context at the host computer system, the guest context relying on a filesystem image stored in a remote image repository; creating a reflector disk for the filesystem image, the reflector disk representing data blocks of the filesystem image without storing the data blocks of the filesystem image; receiving a read request at the reflector disk from a requestor, wherein the read request specifies a read offset and a read length within the filesystem image; obtaining a set of data blocks from the remote image repository based on receiving the read request at the reflector disk, the set of data blocks corresponding to the read offset the read length within the filesystem image; and at the reflector disk, presenting the set of data blocks to the requestor.

In some aspects, the techniques described herein relate to methods, systems, and computer program products, including: identifying a request to start a guest context at the host computer system, the guest context relying on a filesystem image stored in a remote image repository; creating a plurality of reflector disks for the filesystem image, each reflector disk representing data blocks of a corresponding data layer of the filesystem image without storing the data blocks of the corresponding data layer; receiving a read request at a reflector disk in the plurality of reflector disks, wherein the read request specifies a read offset and a read length within a data layer of the filesystem image; obtaining a set of data blocks from the remote image repository based on receiving the read request at the reflector disk, the set of data blocks corresponding to the read offset the read length within the data layer of the filesystem image; and at the reflector disk, presenting the set of data blocks to a requestor.

In some aspects, the techniques described herein relate to methods, systems, and computer program products, including: identifying a request to start a guest context, the guest context relying on a filesystem image stored in a remote image repository; creating a plurality of reflector disks for the filesystem image, each reflector disk representing data blocks of a corresponding data layer of the filesystem image without storing the data blocks of the corresponding data layer; associating a local cache with the plurality of reflector disks; receiving a read request at a reflector disk in the plurality of reflector disks, wherein the read request specifies a read offset and a read length within a data layer of the filesystem image; obtaining a set of data blocks from the remote image repository based on receiving the read request at the reflector disk, the set of data blocks corresponding to the read offset the read length within the data layer of the filesystem image; caching the set of data blocks at the local cache; and at the reflector disk, presenting the set of data blocks to a requestor.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates streaming a filesystem image from an image store to a host system;

FIG. 2 illustrates an example of streaming data blocks from a single-layer container image;

FIG. 3 illustrates an example of streaming data blocks from a multi-layer container image;

FIG. 4 illustrates an example of pre-fetching when streaming data blocks from a container image;

FIG. 5 illustrates a flow chart of an example of a method for streaming a filesystem image from an image store to a host system;

FIG. 6 illustrates an example of a computer architecture that facilitates constructing a filesystem image based on telemetry about how a guest context previously consumed the filesystem image;

FIG. 7 illustrates an example of generating a filesystem image optimized for guest context startup; and

FIG. 8 illustrates an example of consuming a filesystem image that has been optimized for guest context startup.

### DETAILED DESCRIPTION

In many hosting environments, filesystem images, such as tarballs, are stored in a centralized image store accessible by several host systems. As such, individual host systems must download and extract one or more filesystem images for a given guest context before the host system can start that guest context. This process can be slow and inefficient, especially if the filesystem image is large or the network bandwidth is low. This can lead to a significant delay (e.g., many minutes) when starting a guest context. Moreover, the host system may download and extract more data than is needed for the guest context to start up and operate, wasting time and resources (e.g., network bandwidth, processing resources at the host system, local storage resources at the host system).

Embodiments described herein address the challenge of delayed startups of guest contexts, such as containers and virtual machines (VMs), due to the need to fetch large filesystem images stored in a centralized image store before starting a guest context. In particular, rather than fetching and extracting an entire filesystem image as is conventional, the embodiments described herein utilize a novel system architecture, combined with filesystem images that store file data and filesystem metadata separately, that enables a host system to fetch only the parts of the filesystem image that are required for container startup. This approach significantly reduces startup lag for guest contexts, as only a small portion of filesystem images are typically used for startup. For example, in testing, it has been observed that the embodiments described herein typically reduce startup lag by 50-90%, with about 10-50% of the contents of many filesystem images being required for startup. As such, the embodiments described herein significantly reduce guest context startup time, reduce network utilization, and conserve the processing and local storage resources at host systems.

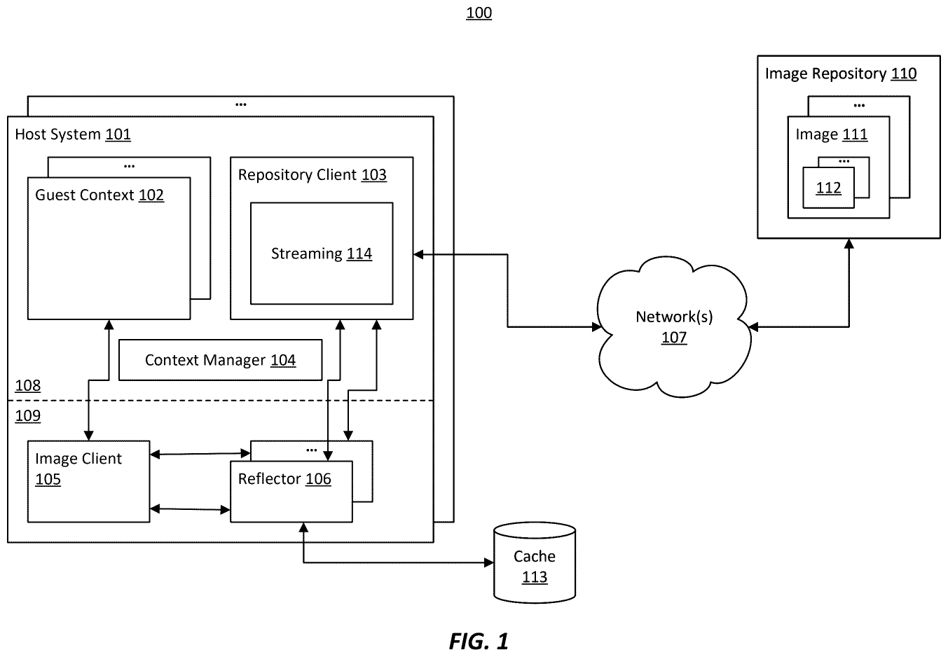

FIG. 1 illustrates an example of computer architecture 100 that facilitates streaming a filesystem image from an image store to a host system. Computer architecture 100 includes at least one host computer system (e.g., host system 101) and an image repository computer system (image repository 110). As shown with an ellipsis, the computer architecture 100 may include a plurality of host systems, and the embodiments of the host system 101 described each applicable to each host system. Each host system is connected to the image repository 110 via network(s) 107. Each computer system shown in FIG. 1 includes a processor system (e.g., a single processor or a plurality of processors), a memory (e.g., system or main memory), a storage medium (e.g., a single computer-readable storage medium, or a plurality of computer-readable storage media), and a network interface (e.g., one or more network interface cards) for interconnecting (e.g., network(s) 107) to other computer systems.

In embodiments, each host system, including host system 101, hosts one or more guest compute environments, such as containers and/or VMs. Thus, host system 101 is illustrated as including a context manager 104 (e.g., a container daemon, a hypervisor, a virtualization stack) and a guest context 102 managed by the context manager 104. An ellipsis associated with guest context 102 indicates that host system 101 can host any number of guest contexts, including container(s), VM(s), and/or a combination of containers and VMs.

Each guest context needs access to one or more filesystem images for its operation. For example, as a container, the guest context 102 may need access to application files and data that support the container's operation. As a VM, the guest context 102 may need access to OS files, application files, and data that support the VM's operation. In computer architecture 100, the host system 101 obtains needed filesystem images from the image repository 110 via network(s) 107. For example, image repository 110 is illustrated as including a filesystem image (image 111). An ellipsis associated with image 111 indicates that image repository 110 can store any number of filesystem images. For example, the image repository 110 may store images associated with different OS types (e.g., WINDOWS, LINUX, FREEBSD), with different OS versions and configurations, with different containerized applications, and the like. In some embodiments, the image repository 110 stores generic public images that can be utilized by various customers/tenants. Additionally, or alternatively, the image repository 110 may store specialized private images that are utilized by specific customers/tenants.

Currently, host systems download and extract an entire filesystem image, such as a tarball, before their context managers can start a guest context that relies on the entire filesystem image. This can lead to a significant, often many-minute, lag in starting guest contexts. In computer architecture 100, however, the host system 101 steams the contents of needed filesystem images on-demand, enabling context manager 104 to initiate the startup of guest context 102, often even before host system 101 has obtained any file data blocks from image repository 110. For example, the host system 101 is illustrated as including a repository client 103 (e.g., a client of image repository 110) that includes a streaming component 114 that is capable of requesting specific sets of data blocks from filesystem images stored in image repository 110, rather than requesting the filesystem images in their entireties.

In embodiments, the on-demand streaming of filesystem images is enabled by reflector disks, such as reflector disk 106. In embodiments, a reflector disk is a software component that receives read I/O requests from a requesting entity, such as image client 105 or guest context 102, and forwards or “reflects” those read I/O requests to repository client 103. Repository client 103 then fetches the appropriate data blocks from a filesystem image (e.g., image 111) stored in image repository 110 and forwards those data blocks to the reflector disk. The reflector disk then returns the data blocks to the requestor. Thus, in embodiments, a reflector disk represents data blocks of a filesystem image to a requestor without actually containing the data blocks of the filesystem image.

In embodiments, reflector disks operate in connection with filesystem images that store file data and filesystem metadata separately. For example, when context manager 104 requests image 111 from repository client 103 for supporting guest context 102, streaming component 114 initially fetches the filesystem metadata of image 111 from image repository 110. This filesystem metadata provides information about the filesystem represented by image 111, such as files and associated attributes (e.g., names, permissions, size, creation times), a directory structure, volume information (if applicable), and the like. Based on this filesystem metadata, a requestor can identify requested files and initiate read I/O request(s) to reflector disk(s).

In some embodiments, image client 105 consumes the filesystem metadata, presenting it to the guest context 102, and image client 105 is the requestor that initiates I/O request(s) to the reflector disk 106. In other embodiments, the guest context 102 consumes the filesystem metadata directly, and the guest context 102 is the requestor that initiates I/O request(s) to the reflector disk 106. The host system 101 may lack image client 105 in these latter embodiments.

In some embodiments, the image repository 110 stores filesystem images using the composite image (CIM) format from MICROSOFT CORPORATION. However, other embodiments may use other filesystem image formats that separate file data and filesystem metadata. In embodiments, the CIM format used by image repository 110 is a block-based read-only virtual disk image comprising one or more layers. Each layer contains files and/or directories organized according to a filesystem hierarchy. The layers can be combined (e.g., merged) at runtime to create a unified view of the CIM's filesystem. The layers can be shared among multiple CIMs, reducing storage overhead and improving performance. For example, image 111 includes layer 112, with an ellipsis indicating that image 111 can include any number of layers. In embodiments, a single layer, such as layer 112, may be used by more than one image.

In embodiments, a CIM may include a base layer and one or more overlay layers. In some examples, the base layer can provide the core files and directories for the guest context, such as the OS kernel, system libraries, and configuration files. The overlay layer(s) can provide additional files and directories that augment or override the base layer, such as application files, user data, settings, and so on.

A CIM also includes metadata that stores information about the structure and content of the CIM, such as the number of layers, the size of each layer, a checksum of each layer, the order of merging the layers, the permissions of each file and directory, and so on. The metadata can be used to validate, mount, and access the files and directories in the CIM.

In embodiments, the host system 101 creates a different set of one or more reflector disks for each guest context. In some embodiments, the host system 101 creates a different instance of image client 105 for each guest context, but other embodiments could use a single instance of image client 105 for more than one guest context. In embodiments, when using multi-layer filesystem images, such as CIMs, the host system 101 creates a different reflector disk for each layer of the filesystem image. In these embodiments, a given reflector disk directs read I/O requests to its corresponding layer of the filesystem image. In embodiments that include the image client 105, the image client 105 assembles and merges information received from the various reflector disks, based on the filesystem image metadata. In embodiments that lack the image client 105, the guest context 102 assembles and merges information received from the various reflector disks, based on the filesystem image metadata.

In embodiments, the reflector disks write received data blocks locally to cache 113. Then, if the reflector disks receive a subsequent read I/O request that includes data blocks stored in cache 113, the reflector disk can serve those data blocks from cache 113 rather than streaming them from the image repository 110. In some embodiments, several reflector disks cache data blocks to a single cache. In other embodiments, each reflector disk has a corresponding cache. For instance, each reflector disk could utilize a different cache file, database, or cache data volume.

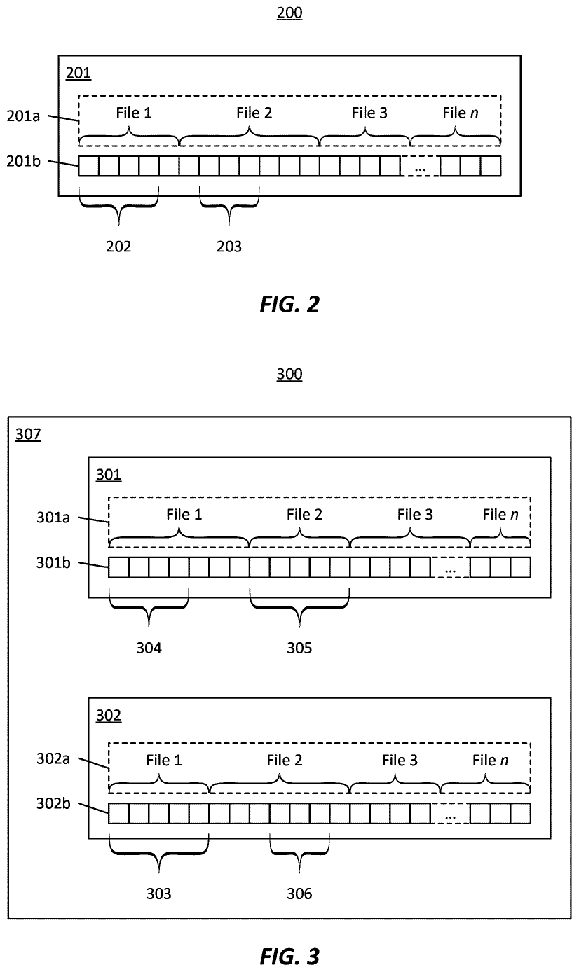

To demonstrate the operation of computer architecture 100, FIG. 2 illustrates an example 200 of streaming data blocks from a single-layer CIM. In FIG. 2, CIM 201 includes a metadata portion 201a and a data portion 201b. Metadata portion 201a describes the filesystem represented by the CIM 201, including files and their attributes (e.g., name, size, relevant dates) and a directory hierarchy. Data portion 201b contains the data blocks corresponding to the files described in the metadata portion 201a. For example, as shown, File 1 corresponds to the first five data blocks, File 2 corresponds to the next seven data blocks, and so on.

Referring to FIGS. 1 and 2, suppose that guest context 102 initiates, via image client 105, two read I/O requests against reflector disk 106, and reflector disk 106 corresponds to CIM 201 stored in image repository 110. Reflector disk 106 forwards these two read I/O requests to image repository 110, which processes them against CIM 201. FIG. 2 shows that image repository 110 returns a first set of data blocks 202 (e.g., all of File 1) in response to the first read I/O request and that image repository 110 returns a second set of data blocks 203 (e.g., a portion of File 2) in response to the second read I/O request. When reflector disk 106 receives these data blocks, it communicates them to image client 105. In turn, image client 105 communicates them to guest context 102. In embodiments, reflector disk 106 may cache these data blocks to cache 113 to respond to future requests for those blocks without fetching them from image repository 110.

FIG. 3 illustrates an example 300 of streaming data blocks from a multi-layer CIM. In FIG. 3, CIM 307 includes two layers, layer 301 and layer 302. Each layer includes a corresponding metadata portion and data portion (e.g., metadata portion 301a and data portion 301b in layer 301, and metadata portion 302a and data portion 302b in layer 302). Layer 301 and layer 302 each store a plurality of files. For example, layer 301 may store files for a base OS image, and layer 302 may store files for an application that executes within that base OS. The files in layer 301 and layer 302 may be unique (e.g., there is no overlap between the files in layer 301 and layer 302), or there may be some overlap. In embodiments, when there is overlap, a merge precedence indicates which file should be visible from the perspective of the CIM 307. For example, a file in layer 301 may take precedence over a corresponding file in layer 302 or vice versa.

Referring to FIGS. 1 and 3, suppose that guest context 102 initiates, via image client 105, four read I/O requests against the reflector disks. For example, reflector disk 106 may correspond to CIM 307 in its entirety, or different reflector disks may correspond to layers 301 and 302, respectively. Regardless of the mapping, the reflector disk(s) forward these four read I/O requests to image repository 110, which processes them against CIM 307. FIG. 3 shows that image repository 110 returns a first set of data blocks 303 (e.g., all of File 1 in layer 302) in response to the first read I/O request, that image repository 110 returns a second set of data blocks 304 (e.g., a portion of File 1 in layer 301) in response to the second read I/O request, that image repository 110 returns a third set of data blocks 305 (e.g., all of File 2 in layer 301) in response to the third read I/O request, and that image repository 110 returns a fourth set of data blocks 306 (e.g., a portion of File 2 in layer 302) in response to the fourth read I/O request. When the reflector disk(s) receive these data blocks, they communicate them to image client 105. In turn, image client 105 communicates them to guest context 102. In embodiments, the reflector disk(s) may cache these data blocks to cache 113 to respond to future requests for those blocks without needing to fetch them from image repository 110.

In some embodiments, when a read I/O request is received at reflector disk 106, streaming component 114 fetches the number of data blocks the read request covers (e.g., based on an offset and length). In other embodiments, the streaming component 114 fetches more data blocks than the requested number of data blocks. For example, a typical read request may request a set of data blocks, each 512 KB, 4 KB, etc. So, if the length of a read request is eight 512 KB data blocks, the request may be for 4 MB of data. Instead of streaming this amount of data from image repository 110, streaming component 114 may stream some additional amount, such as a multiple of the requested data or a fixed amount beyond the requested data. Because read requests often request sequential, or at least nearby, blocks of data, this means that streaming component 114 is effectively pre-fetching data that is likely to be requested in subsequent read requests.

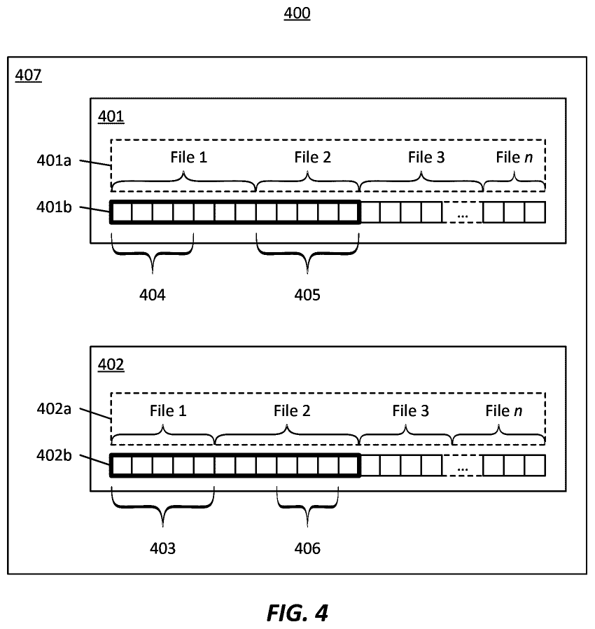

FIG. 4 illustrates an example 400 of pre-fetching when streaming data blocks from a container image. Example 400 includes a CIM 407 that mirrors the CIM 307 of example 300, e.g., layer 401 corresponds to layer 301, layer 402 corresponds to layer 302, and so on. In example 400, however, streaming component 114 requests more than the requested data blocks for a given read request. For example, in example 300, streaming component 114 would have requested data blocks 403 in response to the first read request from guest context 102, and streaming component 114 would have requested data blocks 404 in response to the second read request from guest context 102. However, in example 400, streaming component 114 requests additional data blocks that exceed the requested amount, as indicated by heavy boxes covering the data blocks of both File 1 and File 2 in layers 401 and 402. This means that all the data blocks covered by those heavy boxes are cached at cache 113 after the first and second read requests. As a result, when the guest context 102 issues the third and fourth read requests, the requested data blocks (e.g., data blocks 405 and 406, respectively) can be served from cache 113 rather than needing to be streamed from the image repository 110.

Notably, pre-fetching data likely to be requested in subsequent read requests can lead to decreased read latency and decreased processor utilization at host system 101, particularly for frequent patterns of sequential reads. For example, in host system 101, reflector disk 106 operates in kernel mode 109, while repository client 103 operates in user mode 108. A time and processing penalty occurs when transitioning between user and kernel mode, as certain processor states (e.g., registers, caches) may need to be saved, restored, or even flushed at each transition. By avoiding streaming some read requests based on pre-fetching, these costly transitions between user and kernel modes are avoided. Further, avoiding streaming some read requests based on pre-fetching also avoids network hops from host system 101 to image repository 110, decreasing latency further and reducing network congestion.

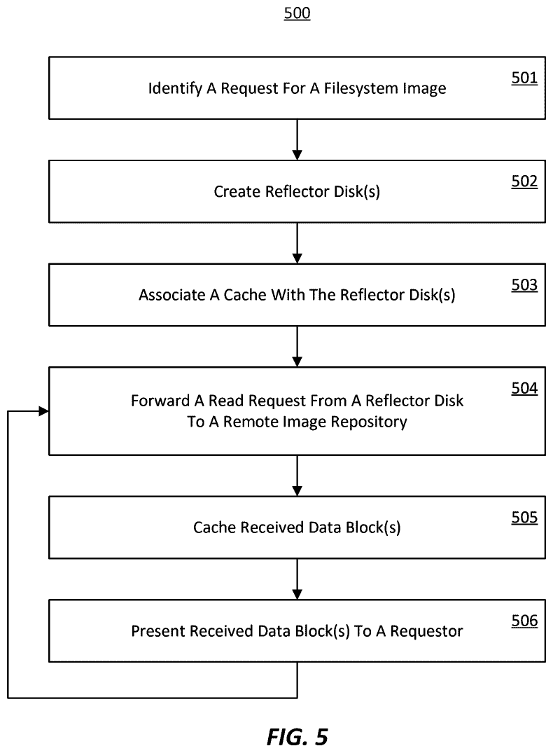

Embodiments are now described in connection with FIG. 5, which illustrates a flow chart of an example method 500 for streaming a filesystem image from an image store to a host system. In embodiments, instructions for implementing method 500 are encoded as computer-executable instructions (e.g., streaming component 114, context manager 104, reflector disk 106, and/or image client 105) stored on a computer storage medium that are executable by a processor system to cause a computer system (e.g., host system 101) to perform method 500.

The following discussion now refers to a method and method acts. Although the method acts are discussed in specific orders or illustrated in a flow chart as occurring in a particular order, no order is required unless expressly stated or required because of another act being completed before the act is performed.

Referring to FIG. 5, in embodiments, method 500 comprises an act 501 of identifying a request for a filesystem image. In some embodiments, act 501 comprises identifying a request to start a guest context, the guest context relying on a filesystem image stored in a remote image repository. For example, based on starting guest context 102, the context manager 104 determines that guest context 102 needs access to image 111, stored in image repository 110, for its operation.

Method 500 also comprises an act 502 of creating one or more reflector disks. In some embodiments, act 502 comprises creating a reflector disk for the filesystem image, the reflector disk representing data blocks of the filesystem image without storing the data blocks of the filesystem image. For example, the context manager 104 creates one or more reflector disks (e.g., reflector disk 106) for image 111. In embodiments, image 111 includes at least a block-based data portion, and the reflector disk 106 represents that block-based data portion, enabling a requestor, such as guest context 102 or image client 105, to direct read I/O requests towards image 111.

In some embodiments, the filesystem image comprises a plurality of data layers, and act 502 comprises creating a plurality of reflector disks for the filesystem image, each reflector disk representing data blocks of a corresponding data layer of the filesystem image without storing the data blocks of the corresponding data layer. For example, image 111 may be a multi-layer filesystem image, such as a CIM, in which each layer represents a different filesystem layer of a plurality of filesystem layers (e.g., a base OS filesystem layer, an application overlay layer, etc.). In some embodiments, the context manager 104 creates a single reflector disk for this multi-layer filesystem image as a whole. In other embodiments, however, the context manager 104 creates a different reflector disk for each layer of the multi-layer filesystem image.

In embodiments, the context manager 104 may also create an instance of image client 105 to facilitate the guest context 102 making read I/O requests against image 111. For example, based on metadata received from image 111, image client 105 may present image 111 to the guest context 102 as if it were a local filesystem at the guest context 102. Image client 105 may make additional translations needed for compatibility with image 111, such as determining which layer of image 111 a given read I/O request is directed to and routing that read I/O request to a reflector disk corresponding to that layer. Thus, in embodiments, image client 105 is a filesystem merging component that merges the plurality of data layers on behalf of the guest context.

In some embodiments, method 500 also comprises an act 503 of associating a cache with the reflector disk(s). In some embodiments, act 503 comprises associating a local cache with the plurality of reflector disks. For example, context manager 104 associates cache 113 with the reflector disk(s) created in act 502. In some embodiments, a single cache supports the operation of a plurality of reflector disks. In other embodiments, there is a different cache for each reflector disk. For example, associating the local cache with the plurality of reflector disks may comprise associating a different local cache portion (e.g., cache file, cache volume) with each reflector disk in a plurality of reflector disks.

Method 500 also comprises an act 504 of forwarding a read request from a reflector disk to a remote image repository. In some embodiments, act 503 comprises receiving a read request at a reflector disk in the plurality of reflector disks, wherein the read request specifies a read offset and a read length within a data layer of the filesystem image. Then, based on receiving the read request, act 503 comprises obtaining a set of data blocks from the remote image repository based on receiving the read request at the reflector disk, the set of data blocks corresponding to the read offset the read length within the data layer of the filesystem image. For example, guest context 102 initiates a read I/O request to reflector disk 106 directly or via image client 105, which specifies one or more data blocks (e.g., by specifying a read offset and length). Upon receiving the read I/O request, the reflector disk 106 forwards the request to repository client 103, which uses streaming component 114 to dynamically fetch the data blocks from image 111 in image repository 110 (e.g., data blocks 202 in FIG. 2, data blocks 303 in FIG. 3).

As discussed in connection with FIG. 4, some embodiments pre-fetch data that is likely to be requested in subsequent read requests by fetching more than the requested data for a given read. Thus, in some embodiments of method 500, the set of data blocks exceeds the read length.

Method 500 also comprises an act 505 of caching received data block(s). In some embodiments, act 505 comprises caching the set of data blocks at the local cache. For example, upon receipt of the data blocks from repository client 103, reflector disk 106 may cache them in cache 113. Then, if those same data blocks are requested again from guest context 102 or even from another guest context, reflector disk 106 can obtain them from cache 113 rather than request them from repository client 103.

Method 500 also comprises an act 506 of presenting received data block(s) to a requestor. In some embodiments, act 506 comprises presenting, by the at the reflector disk, the set of data blocks to a requestor. For example, upon receipt of the data blocks from repository client 103, repository client 103 routes them to reflector disk 106, which provides them to guest context 102 directly or via image client 105.

As indicated by an arrow extending from act 506 to act 504, these acts can repeat any number of times, e.g., in response to additional read I/O requests from guest context 102. For example, in response to a second read I/O request, reflector disk 106 may stream additional data blocks from image repository 110 (e.g., if they are not already present in cache 113) or may serve existing data blocks from cache 113 if they have already been streamed from image repository 110.

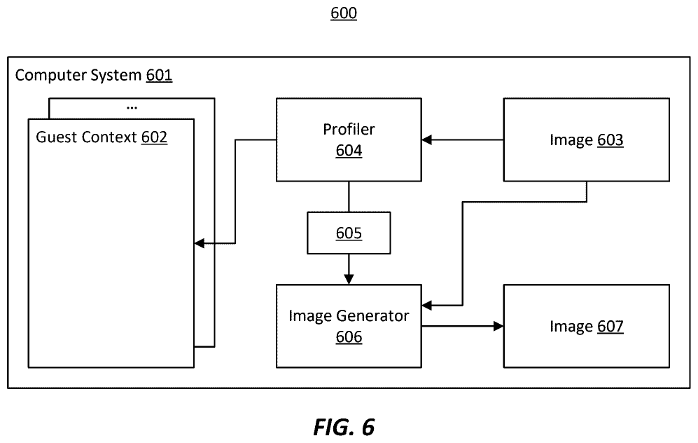

As described, FIG. 4 illustrates an example 400 of pre-fetching when streaming data blocks from a container image. In some embodiments, computer architecture 100 relies on filesystem images that are specifically created for efficient streaming, particularly in the context of guest context startup. FIG. 6-8 illustrate embodiments for creating and using filesystem images tailored for efficient guest context startup.

FIG. 6 illustrates an example of a computer architecture 600 that facilitates constructing a filesystem image based on telemetry about how a guest context previously consumed the filesystem image. Computer architecture 600 includes a computer system 601 that hosts a guest context 602, though an ellipsis indicates that computer system 601 can host any number of guest contexts. A guest context 602 can be a container, a VM, or any other type of isolated execution environment that uses a filesystem image 603 to store and access files and data. A filesystem image 603 can be a compressed archive file, such as a tarball or a zip file, that contains a hierarchy of files and directories that represent a filesystem.

The computer system 601 also includes a file access order profiler (profiler 604), which is a component that monitors and records the read I/O requests issued by a guest context 602 during its startup. For example, the profiler 604 can intercept the system calls issued a guest context 602 to open and read files from the filesystem image 603. The profiler 604 may be implemented as a software module, hardware device, or combination. It may intercept the read I/O requests at various levels of the system stack, such as a hypervisor, a host OS, or a storage driver. The profiler 604 generates read profile data 605 based on the observed read I/O requests, which indicates, or can be used to determine, an order in which the guest context 602 reads files from the filesystem image 603. For instance, the read profile data 605 can be a list of file names or file identifiers, along with information reflecting the order of file access by the guest context 602. In another example, the read profile data 605 may include, for example, a list of files and their corresponding block numbers, offsets, and sizes, or a heatmap of the accessed regions of the filesystem image 603.

An image generator 606 consumes the read profile data 605 and the filesystem image 603 to generate a filesystem image 607 optimized for guest context startup. The image generator 606 may be implemented as a software module, hardware device, or combination. It may operate on the same or a different computer system as the profiler 604. In embodiments, the image generator 606 utilizes the read profile data 605 to determine an order in which to arrange data blocks when generating filesystem image 607. In particular, based on read profile data 605, the image generator 606 determines an ordering among at least a subset of files to be written into filesystem image 607. Then when image generator 606 writes data blocks corresponding to those files into filesystem image 607, it sequentially arranges those data blocks to correspond to that determined ordering. Thus, at least a portion of the data blocks within filesystem image 607 are arranged so that a first set of data blocks corresponding to a first file appears first, a second set of data blocks corresponding to a second file appears next, and so on, with the ordering of those files being based on an ordering of files previously read by guest context 602 from filesystem image 603 during its startup. This sequential layout of the data blocks enhances the performance of read-ahead caching and pre-fetching mechanisms, as the likelihood of pre-fetching and caching the data that will be subsequently loaded during guest context startup is significantly increased. Moreover, the filesystem image 607 may reduce the latency and bandwidth requirements for downloading or streaming the filesystem image from a remote source, as the data needed for guest context startup is likely downloaded or streamed first.

In some embodiments, the image generator 606 obtains one or more from filesystem image 603 when generating filesystem image 607, as indicated by an arrow extending from filesystem image 603 to image generator 606. Additionally, or alternatively, the image generator 606 may obtain files from one or more other sources, such as a project build directory. In some situations, the files within filesystem image 607 may correspond precisely to the files within filesystem image 603, with the arrangement of data blocks within filesystem image 607 being optimized for container startup, compared to filesystem image 603. In other situations, the files within filesystem image 607 may differ somewhat from those within filesystem image 603. For example, filesystem image 603 may correspond to an older build or version of an OS or application compared to filesystem image 607. However, even though the identity and/or contents of files within filesystem image 607 may not be identical to those in filesystem image 603, in many situations, the order in which specific files were read by guest context 602 from filesystem image 603 during its startup will generally correspond to the order in which corresponding files (even if their contents are not identical) will be read by another guest context from filesystem image 607 during its startup.

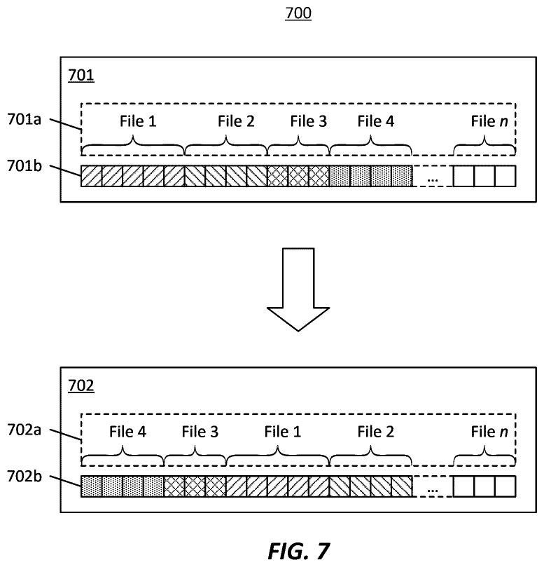

FIG. 7 illustrates an example 700 of generating a filesystem image optimized for guest context startup. In FIG. 7, a filesystem image 701, such as a single-layer CIM, includes a metadata portion 701a and a data portion 701b. The metadata portion 701a describes the filesystem represented by the filesystem image 701, including files and their attributes (e.g., name, size, relevant dates) and a directory hierarchy. The data portion 701b contains the data blocks corresponding to the files described in the metadata portion 701a. For example, as shown, File 1 corresponds to the first five data blocks, File 2 corresponds to the next seven data blocks, and so on. Example 700 uses various patterns to indicate which data blocks in data portion 701b correspond to the files described in metadata portion 701a.

In FIG. 7, an arrow indicates a transformation (e.g., by image generator 606) of filesystem image 701 to filesystem image 702, optimized for guest container startup, based on read profile data 605, indicating that the files in filesystem image 701 were accessed in the order of File 4, then File 3, then File 1, then File 2 during a host context startup. Filesystem image 702 similarly includes a metadata portion 702a and a data portion 702b, including the same files contained in filesystem image 701. However, in computer system 601, image generator 606 has re-arranged the data blocks, such that they appear in the order of File 4, then File 3, then File 1, then File 2, consistent with the read profile data 605.

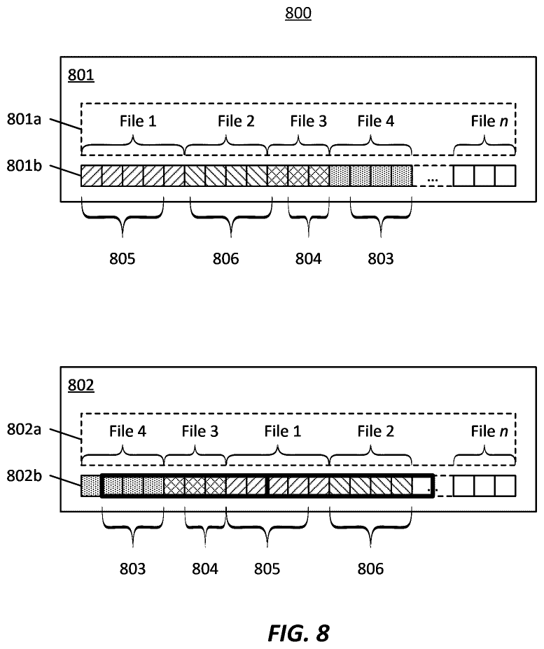

FIG. 8 illustrates an example 800 of consuming a filesystem image optimized for guest context startup. In particular, example 800 includes a filesystem image 801 that mirrors filesystem image 701 of FIG. 7 (e.g., a metadata portion 801a corresponds to metadata portion 701a, and a data portion 801b corresponds to data portion 701b, with the same files and data blocks). Example 800 shows four reads made by a guest context against filesystem image 801, including a first read (data blocks 803) from a portion of File 4, a second read (data blocks 804) from a portion of File 4, a third read (data blocks 805) from a portion of File 1, and a fourth read (data blocks 806) from a portion of File 2.

Example 800 also includes a filesystem image 802 that mirrors the filesystem image 702 of FIG. 7 (e.g., a metadata portion 802a corresponds to metadata portion 2a, and a data portion 802b corresponds to data portion 2b, with the same files and data blocks). Example 800 shows how the same four reads (data blocks 803-806) made by a guest context would map to filesystem image 802. Notably, these reads now follow a pattern of generally sequential access to the data blocks in data portion 802b. However, example 800 uses two boxes with heavy lines (each covering eight data blocks) to show that, rather than fetching the requested data blocks for a given read, some embodiments may pre-fetch some additional data blocks (e.g., a total of eight data blocks for each read, in this example). For example, the first read may fetch the three requested data blocks (data blocks 803) corresponding to File 4, plus five additional data blocks corresponding to the entirety of File 3 and a part of File 1. This means that, when the guest context issues the second read, the requested data blocks (data blocks 804) have already been acquired from filesystem image 802. That read can, therefore, be fulfilled from a cache rather than filesystem image 802. The third read (data blocks 805) may be partially fulfilled from a cache. Still, as shown, when fetching the remaining data blocks from filesystem image 802, some additional data blocks may be fetched as well, meaning that when the fourth read (data blocks 806) is issued by the guest context, that read can be fulfilled from a cache. Thus, in example 800, only two reads of four reads are processed against filesystem image 802, leading to improved read latency.

Returning to method 500, in some embodiments, host system 101 includes profiler 604 and/or image generator 606 to facilitate the generation of startup-optimized filesystem images. Thus, for example, in embodiments, method 500 further comprises logging the set of data blocks as being relevant to starting the guest context and/or generating the filesystem image based on logging the set of data blocks as being relevant to starting the guest context.

Alternatively or in addition to the other examples described herein, examples include any combination of the following:
Clause 1. A method implemented in a host computer system that includes a processor system, comprising: identifying a request to start a guest context at the host computer system, the guest context relying on a filesystem image stored in a remote image repository; creating a reflector disk for the filesystem image, the reflector disk representing data blocks of the filesystem image without storing the data blocks of the filesystem image; receiving a read request at the reflector disk, wherein the read request specifies a read offset and a read length within the filesystem image; obtaining a set of data blocks from the remote image repository based on receiving the read request at the reflector disk, the set of data blocks corresponding to the read offset the read length within the filesystem image; and at the reflector disk, presenting the set of data blocks to a requestor.
Clause 2. The method of clause 1, wherein: the filesystem image comprises a plurality of data layers, each data layer representing a different filesystem layer of a plurality of filesystem layers, creating the reflector disk for the filesystem image comprises creating a plurality of reflector disks for the filesystem image, each reflector disk corresponding to a different data layer in the plurality of data layers of the filesystem image, the reflector disk corresponding to a particular data layer of the filesystem image, and the set of data blocks correspond to the read offset the read length within the particular data layer of the filesystem image.
Clause 3. The method of clause 2, wherein the requestor is a filesystem merging component that merges the plurality of data layers on behalf of the guest context.
Clause 4. The method of any one of clause 2 to claim 3, wherein the method further comprises: associating a local cache with the plurality of reflector disks; and caching the set of data blocks at the local cache.
Clause 5. The method of clause 4, wherein associating the local cache with the plurality of reflector disks comprises associating a different local cache portion with each reflector disk in the plurality of reflector disks.
Clause 6. The method of any one of clauses 1, 2, 4, or 5, wherein the requestor is the guest context.
Clause 7. The method of any one of clause 1 to claim 6, wherein the filesystem image is block-based.
Clause 8. The method of any one of clause 1 to claim 7, wherein the set of data blocks exceeds the read length.
Clause 9. The method of any one of clause 1 to claim 8, wherein the method further comprises logging the set of data blocks as being relevant to starting the guest context.
Clause 10. The method of any one of clause 1 to claim 9, wherein: the read request is a first read request, and the method further comprises: receiving a second read request at the reflector disk, wherein the second read request is received from the requestor; determining that the second read request corresponds to the set of data blocks; and presenting the set of data blocks from a local cache to the requestor.
Clause 11. A host computer system, comprising: a processor system; and a computer storage medium that stores computer-executable instructions that are executable by the processor system to at least: identify a request to start a guest context at the host computer system, the guest context relying on a filesystem image stored in a remote image repository; create a plurality of reflector disks for the filesystem image, each reflector disk representing data blocks of a corresponding data layer of the filesystem image without storing the data blocks of the corresponding data layer; receive a read request at a reflector disk in the plurality of reflector disks, wherein the read request specifies a read offset and a read length within a data layer of the filesystem image; obtain a set of data blocks from the remote image repository based on receiving the read request at the reflector disk, the set of data blocks corresponding to the read offset the read length within the data layer of the filesystem image; and at the reflector disk, present the set of data blocks to a requestor.
Clause 12. The host computer system of clause 11, wherein the requestor is a filesystem merging component that merges data layers of the filesystem image on behalf of the guest context.
Clause 13. The host computer system of clause 11, wherein the requestor is the guest context.
Clause 14. The host computer system of any one of clause 11 to claim 13, wherein the computer-executable instructions are also executable by the processor system to: associate a local cache with the plurality of reflector disks; and cache the set of data blocks at the local cache.
Clause 15. The host computer system of clause 14, wherein associating the local cache with the plurality of reflector disks comprises associating a different local cache portion with each reflector disk in the plurality of reflector disks.
Clause 16. The host computer system of any one of clause 11 to claim 15, wherein the filesystem image is block-based.
Clause 17. The host computer system of any one of clause 11 to claim 16, wherein the set of data blocks exceeds the read length.
Clause 18. The host computer system of any one of clause 11 to claim 17, wherein the computer-executable instructions are also executable by the processor system to log the set of data blocks as being relevant to starting the guest context.
Clause 19. The host computer system of any one of clause 11 to claim 18, wherein: the read request is a first read request, and the computer-executable instructions are also executable by the processor system to: receive a second read request at the reflector disk, wherein the second read request is received from the requestor; determine that the second read request corresponds to the set of data blocks; and present the set of data blocks from a local cache to the requestor.
Clause 20. A computer storage medium that stores computer-executable instructions that are executable by a processor system to at least: identify a request to start a guest context, the guest context relying on a filesystem image stored in a remote image repository; create a plurality of reflector disks for the filesystem image, each reflector disk representing data blocks of a corresponding data layer of the filesystem image without storing the data blocks of the corresponding data layer; associate a local cache with the plurality of reflector disks; receive a read request at a reflector disk in the plurality of reflector disks, wherein the read request specifies a read offset and a read length within a data layer of the filesystem image; obtain a set of data blocks from the remote image repository based on receiving the read request at the reflector disk, the set of data blocks corresponding to the read offset the read length within the data layer of the filesystem image; cache the set of data blocks at the local cache; and at the reflector disk, present the set of data blocks to a requestor.

Embodiments of the disclosure comprise or utilize a special-purpose or general-purpose computer system (e.g., host system 101) that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a host computer system that includes a processor system, comprising:
identifying a request to start a guest context at the host computer system, the guest context relying on a filesystem image stored in a remote image repository;
creating a reflector disk for the filesystem image, the reflector disk representing data blocks of the filesystem image without storing the data blocks of the filesystem image;
receiving a read request at the reflector disk from a requestor, wherein the read request specifies a read offset and a read length within the filesystem image;
obtaining a set of data blocks from the remote image repository based on receiving the read request at the reflector disk, the set of data blocks corresponding to the read offset the read length within the filesystem image; and
at the reflector disk, presenting the set of data blocks to the requestor.

2. The method of claim 1, wherein:
the filesystem image comprises a plurality of data layers, each data layer representing a different filesystem layer of a plurality of filesystem layers,
creating the reflector disk for the filesystem image comprises creating a plurality of reflector disks for the filesystem image, each reflector disk corresponding to a different data layer in the plurality of data layers of the filesystem image, the reflector disk corresponding to a particular data layer of the filesystem image, and
the set of data blocks correspond to the read offset the read length within the particular data layer of the filesystem image.

3. The method of claim 2, wherein the requestor is a filesystem merging component that merges the plurality of data layers on behalf of the guest context

4. The method of claim 2, wherein the method further comprises:
associating a local cache with the plurality of reflector disks; and
caching the set of data blocks at the local cache.

5. The method of claim 4, wherein associating the local cache with the plurality of reflector disks comprises associating a different local cache portion with each reflector disk in the plurality of reflector disks.

6. The method of claim 1, wherein the requestor is the guest context.

7. The method of claim 1, wherein the filesystem image is block-based.

8. The method of claim 1, wherein the set of data blocks exceeds the read length.

9. The method of claim 1, wherein the method further comprises logging the set of data blocks as being relevant to starting the guest context.

10. The method of claim 1, wherein:
the read request is a first read request, and
the method further comprises:
receiving a second read request at the reflector disk, wherein the second read request is received from the requestor;
determining that the second read request corresponds to the set of data blocks; and
presenting the set of data blocks from a local cache to the requestor

11. A host computer system, comprising:
a processor system; and
a computer storage medium that stores computer-executable instructions that are executable by the processor system to at least:
identify a request to start a guest context at the host computer system, the guest context relying on a filesystem image stored in a remote image repository;
create a plurality of reflector disks for the filesystem image, each reflector disk representing data blocks of a corresponding data layer of the filesystem image without storing the data blocks of the corresponding data layer;
receive a read request at a reflector disk in the plurality of reflector disks, wherein the read request specifies a read offset and a read length within a data layer of the filesystem image;
obtain a set of data blocks from the remote image repository based on receiving the read request at the reflector disk, the set of data blocks corresponding to the read offset the read length within the data layer of the filesystem image; and
at the reflector disk, present the set of data blocks to a requestor.

12. The host computer system of claim 11, wherein the requestor is a filesystem merging component that merges data layers of the filesystem image on behalf of the guest context.

13. The host computer system of claim 11, wherein the requestor is the guest context.

14. The host computer system of claim 11, wherein the computer-executable instructions are also executable by the processor system to:
associate a local cache with the plurality of reflector disks; and
cache the set of data blocks at the local cache.

15. The host computer system of claim 14, wherein associating the local cache with the plurality of reflector disks comprises associating a different local cache portion with each reflector disk in the plurality of reflector disks.

16. The host computer system of claim 11, wherein the filesystem image is block-based.

17. The host computer system of claim 11, wherein the set of data blocks exceeds the read length.

18. The host computer system of claim 11, wherein the computer-executable instructions are also executable by the processor system to log the set of data blocks as being relevant to starting the guest context.

19. The host computer system of claim 11, wherein:
the read request is a first read request, and
the computer-executable instructions are also executable by the processor system to:
receive a second read request at the reflector disk, wherein the second read request is received from the requestor;
determine that the second read request corresponds to the set of data blocks; and
present the set of data blocks from a local cache to the requestor.

20. A computer storage medium that stores computer-executable instructions that are executable by a processor system to at least:
identify a request to start a guest context, the guest context relying on a filesystem image stored in a remote image repository;
create a plurality of reflector disks for the filesystem image, each reflector disk representing data blocks of a corresponding data layer of the filesystem image without storing the data blocks of the corresponding data layer;
associate a local cache with the plurality of reflector disks;
receive a read request at a reflector disk in the plurality of reflector disks, wherein the read request specifies a read offset and a read length within a data layer of the filesystem image;
obtain a set of data blocks from the remote image repository based on receiving the read request at the reflector disk, the set of data blocks corresponding to the read offset the read length within the data layer of the filesystem image;
cache the set of data blocks at the local cache; and
at the reflector disk, present the set of data blocks to a requestor.
